(19) United States
(12) Patent Application Publication
(10) Pub. No.: US 2026/0246409 A1
(43) Pub. Date: Aug. 20, 2026

(54) CONTROL DEVICE, WINDING SWITCHING SYSTEM, CONTROL METHOD, AND CONTROL PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Masaki TSUDA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/161,759

(22) PCT Filed: Jan. 26, 2024
(86) PCT No.: PCT/JP2024/002506

§ 371 Date: Sep. 3, 2025

(30) Foreign Application Priority Data
Mar. 3, 2023 (JP) 2023-032856

(51) Int. Cl. H02P 25/18; H02P 23/28; H02P 27/06

(52) U.S. Cl. CPC H02P 25/188; H02P 23/28; H02P 27/06

(57) ABSTRACT

A control device is a control device for controlling an AC motor capable of switching a connection state of a plurality of windings from a first connection state to a second connection state, and includes: a specifying unit that specifies a switching timing at which zero crossing switching for switching the connection state of the plurality of windings of the AC motor from the first connection state to the second connection state at a zero crossing point of current flowing through the windings is executed; and a control value switching unit that switches a control value for controlling the AC motor from a first control value to be used for the first connection state to a second control value to be used for the second connection state based on the switching timing specified by the specifying unit.

### CROSS-REFERENCE TO RELATED APPLICATIONS

This application is the U.S. national stage of PCT/JP2024/002506 filed on Jan. 26, 2024, which claims priority of Japanese Patent Application No. JP 2023-032856 filed on Mar. 3, 2023, the contents of which are incorporated herein.

### TECHNICAL FIELD

The present disclosure relates to a control device, a winding switching system, a control method, and a control program.

### BACKGROUND

Some motors mounted in, for example, electric vehicles are capable of switching between a low-speed, high-torque operating state and a high-speed, low-torque operating state by switching connections of a plurality of windings. JP 2020-072632A discloses a device that specifies a period during which an AC motor current is less than or equal to a predetermined value and switches windings during the specified period in order to prevent a surge voltage.

After switching windings of a motor, it is necessary to change control values such as the duty ratio of a Pulse Width Modulation (PWM) signal. For this reason, not only are the windings switched, but also the control value is switched, and there is a risk of a surge voltage being generated when the control value is switched.

### SUMMARY

A control device according to one aspect of the present disclosure is a control device for controlling an AC motor capable of switching a connection state of a plurality of windings from a first connection state to a second connection state, including: a specifying unit configured to specify a switching timing at which zero crossing switching for switching the connection state of the plurality of windings of the AC motor from the first connection state to the second connection state at a zero crossing point of current flowing through the windings is executed; and a control value switching unit configured to switch a control value for controlling the AC motor from a first control value to be used in the first connection state to a second control value to be used in the second connection state, based on the switching timing specified by the specifying unit.

### Advantageous Effects

According to the present disclosure, it is possible to suppress the occurrence of a surge voltage.

### BRIEF DESCRIPTION OF DRAWINGS

FIG. 1 is a diagram showing an example of a configuration of a winding switching system according to a first embodiment.

FIG. 2 is a circuit diagram showing an example of a configuration of a winding switching device according to the first embodiment.

FIG. 3 is a circuit diagram showing an example of a configuration of a control circuit.

FIG. 4 is a timing chart showing an example of transition of states of signals in the winding switching device according to the first embodiment.

FIG. 5 is a block diagram showing an example of a hardware configuration of a control device according to the first embodiment.

FIG. 6 is a functional block diagram showing an example of functions of the control device according to the first embodiment.

FIG. 7 is a control block diagram showing a control system of a motor of the control device according to the first embodiment.

FIG. 8 is a graph showing examples of winding voltages, winding currents, and switching timing signals for a U-phase, V-phase, and W-phase when a control voltage value of each phase is switched at a timing of zero crossing switching.

FIG. 9 is a flowchart showing an example of motor control processing performed by the control device according to the first embodiment.

FIG. 10 is a circuit diagram showing an example of a configuration of a winding switching device according to a second embodiment.

### DETAILED DESCRIPTION OF PREFERRED EMBODIMENTS

Hereinafter, an overview of embodiments of the present disclosure will be listed and described.

In a first aspect, a control device according to the present embodiment is a control device for controlling an AC motor capable of switching a connection state of a plurality of windings from a first connection state to a second connection state, including: a specifying unit configured to specify a switching timing at which zero crossing switching for switching the connection state of the plurality of windings of the AC motor from the first connection state to the second connection state at a zero crossing point of current flowing through the windings is executed; and a control value switching unit configured to switch a control value for controlling the AC motor from a first control value to be used in the first connection state to a second control value to be used in the second connection state, based on the switching timing specified by the specifying unit. This allows the control value to be switched in accordance with the switching timing for the connection state of the windings, making it possible to suppress the occurrence of a surge voltage.

In a second aspect according to the first aspect, the control device may further include an input unit configured to receive a switching timing signal output by a winding switching device configured to switch the connection state of the plurality of windings at a timing when the zero crossing switching is executed, in which the specifying unit may specify the switching timing based on input of the switching timing signal in the input unit. This makes it possible to specify the actual switching timing for switching the connection state of the windings.

In a third aspect according to the first aspect, the specifying unit may detect a zero crossing point of the current flowing through the windings, and specify the switching timing based on the detected zero crossing point. This makes it possible to specify the switching timing for switching the connection state of the windings.

In a fourth aspect according to the third aspect, the specifying unit may estimate that the next zero crossing point that is to arrive after a switching command to switch the connection state of the plurality of windings is input to a winding switching device configured to switch the connection state of the plurality of windings is the switching timing. This allows estimation of an accurate switching timing.

In a fifth aspect, according to any one of the first to the fourth aspects, the specifying unit may specify a first switching timing, which is the switching timing in a first phase of the AC motor, and a second switching timing, which is the switching timing in a second phase of the AC motor, and the control value switching unit may switch a control value corresponding to the first phase from the first control value to the second control value based on the first switching timing specified by the specifying unit, and switch a control value corresponding to the second phase from the first control value to the second control value based on the second switching timing specified by the specifying unit. This makes it possible to switch the control value in accordance with the switching timing for switching the connection state of the windings in each of the first and second phases.

In a sixth aspect according to any one of the first to the fifth aspects, the control value switching unit may gradually change the control value from the first control value to the second control value. This suppresses instantaneous switching from the first control value to the second control value, thereby making it possible to further suppress the occurrence of a surge voltage.

In a seventh aspect, a winding switching system according to the present embodiment includes: an AC motor capable of switching a connection state of a plurality of windings from a first connection state to a second connection state; a power converter configured to convert power output from a power source into AC power and supply the AC power to the AC motor; a winding switching device configured to execute zero crossing switching for switching the connection state of the plurality of windings from the first connection state to the second connection state at a zero crossing point of current flowing through the windings; and a control device, in which the control device includes: a specifying unit configured to specify a switching timing at which the winding switching device executes the zero crossing switching; and a control value switching unit configured to switch a control value for controlling the AC motor from a first control value to be used in the first connection state to a second control value to be used in the second connection state, based on the switching timing specified by the specifying unit. This allows the control value to be switched in accordance with the switching timing for switching the connection state of the windings, making it possible to suppress the occurrence of a surge voltage.

In an eighth aspect, a control method according to the present embodiment is a control method for controlling an AC motor capable of switching a connection state of a plurality of windings from a first connection state to a second connection state, including: a step of specifying a switching timing at which zero crossing switching for switching a connection state of the plurality of windings of the AC motor from the first connection state to the second connection state at a zero crossing point of current flowing through the windings is executed; and a step of switching a control value for controlling the AC motor from a first control value to be used in the first connection state to a second control value to be used in the second connection state based on the specified switching timing. This allows the control value to be switched in accordance with the switching timing for switching the connection state of the windings, making it possible to suppress the occurrence of a surge voltage.

In a ninth aspect, a control program according to the present embodiment is a control program for controlling an AC motor capable of switching a connection state of a plurality of windings from a first connection state to a second connection state, the control program causing a computer to execute: a step of specifying a switching timing at which zero crossing switching for switching a connection state of the plurality of windings of the AC motor from the first connection state to the second connection state at a zero crossing point of current flowing through the windings is executed; and a step of switching a control value for controlling the AC motor from a first control value to be used in the first connection state to a second control value to be used in the second connection state based on the specified switching timing. This allows the control value to be switched in accordance with the switching timing for switching the connection state of the windings, making it possible to suppress the occurrence of a surge voltage.

The present disclosure can be realized not only as a control device having the above-described characteristic configuration, a winding switching system including the control device, a control method having steps corresponding to characteristic processing in the control device, and a control program for causing a computer to execute the characteristic processing, but also as a semiconductor integrated circuit that realizes part or all of the control device.

Hereinafter, details of the embodiments of the present disclosure will be described with reference to the drawings. Note that at least some of the embodiments described below may be combined in any manner.

### First Embodiment

### Winding Switching System

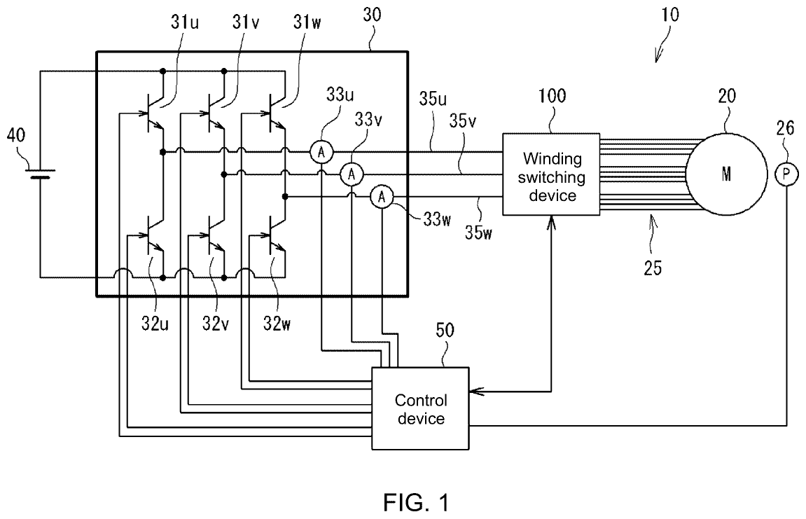

FIG. 1 is a diagram showing an example of a configuration of a winding switching system according to a first embodiment.

The winding switching system 10 is mounted in a vehicle propelled by a motor, such as an electric vehicle or a plug-in hybrid vehicle (hereinafter, referred to as an “electric vehicle”). The winding switching system 10 includes a motor 20, a power converter 30, a battery 40, a control device 50, and a winding switching device 100.

The motor 20 is a travel motor that generates propulsive force for the electric vehicle. The motor 20 is driven by three-phase AC power. An example of the motor 20 is a permanent magnet synchronous motor.

An output shaft of the motor 20 is provided with a position sensor 26. The position sensor 26 detects the rotation angle of the output shaft of the motor 20. The position sensor 26 is, for example, a rotary encoder or a rotary potentiometer. The position sensor 26 is connected to the control device 50 by a signal line. The detection signal of the position sensor 26 is output as a control signal 50.

The battery 40 is a battery for supplying power to drive the motor 20. The battery 40 is a secondary battery, and is, for example, a lithium ion battery.

The power converter 30 is an inverter that converts DC power supplied from the battery 40 into three-phase AC power. The power converter 30 may have a function of converting the three-phase AC power output when the motor 20 functions as a generator into DC power and charging the battery 40.

The power converter 30 includes a leg for each of the U-phase, the V-phase, and the W-phase. The U-phase leg includes switches 31u and 32u, the V-phase leg includes switches 31v and 32v, and the W-phase leg includes switches 31w and 32w. The switches 31u, 32u, 31v, 32v, 31w, and 32w perform switching, whereby the DC power is converted into three-phase AC power. The switches 31u, 32u, 31v, 32v, 31w, and 32w are, for example, insulated gate bipolar transistors (IGBTs) or power metal oxide semiconductor field-effect transistors (MOSFETs).

A power line 35u corresponding to the U-phase extends from the U-phase leg, a power line 35v corresponding to the V-phase extends from the V-phase leg, and a power line 35w corresponding to the W-phase extends from the W-phase leg. In the power converter 30, a current sensor 33u is provided on the power line 35u, a current sensor 33v is provided on the power line 35v, and a current sensor 33w is provided on the power line 35w. The current sensor 33u detects the current value of the U-phase current Iu. The current sensor 33v detects the current value of the V-phase current Iv. The current sensor 33w detects the current value of the W-phase current Iw. The current sensors 33u, 33v, and 33w can detect the current values as well as the DC and AC components of the currents Iu, Iv, and Iw flowing through the power lines 35u, 35v, and 35w. The current sensors 33u, 33v, and 33w are, for example, DC current transformers (DCCTs) or shunt resistors.

The current sensors 33u, 33v, and 33w are connected to the control device 50 by signal lines. The detection values of the current sensors 33u, 33v, and 33w are output to the control device 50.

The winding switching device 100 is disposed between the motor 20 and the power converter 30. However, the location of the winding switching device 100 is not limited to between the motor 20 and the power converter 30. The power converter 30 and the winding switching device 100 are connected to each other by the power lines 35u, 35v, and 35w, and the winding switching device 100 and the motor 20 are connected to each other by a plurality of power lines 25. The winding switching device 100 switches the connection state of a plurality of windings of the motor 20. The configuration of the winding switching device 100 will be described later. Three-phase alternating currents Iu, Iv, and Iw output from the power converter 30 are supplied to the motor 20 via the winding switching device 100.

The control device 50 controls the power converter 30 and the winding switching device 100. Specifically, signal lines extend from the control device 50 to each of the switches 31u, 32u, 31v, 32v, 31w, and 32w, and the control device 50 controls the on/off timing of the switches 31u, 32u, 31v, 32v, 31w, and 32w. A signal line extends from the control device 50 to the winding switching device 100, and the control device 50 outputs a switching command signal for commanding switching of the connection state of the windings to the winding switching device 100.

### Configuration of Winding Switching Device

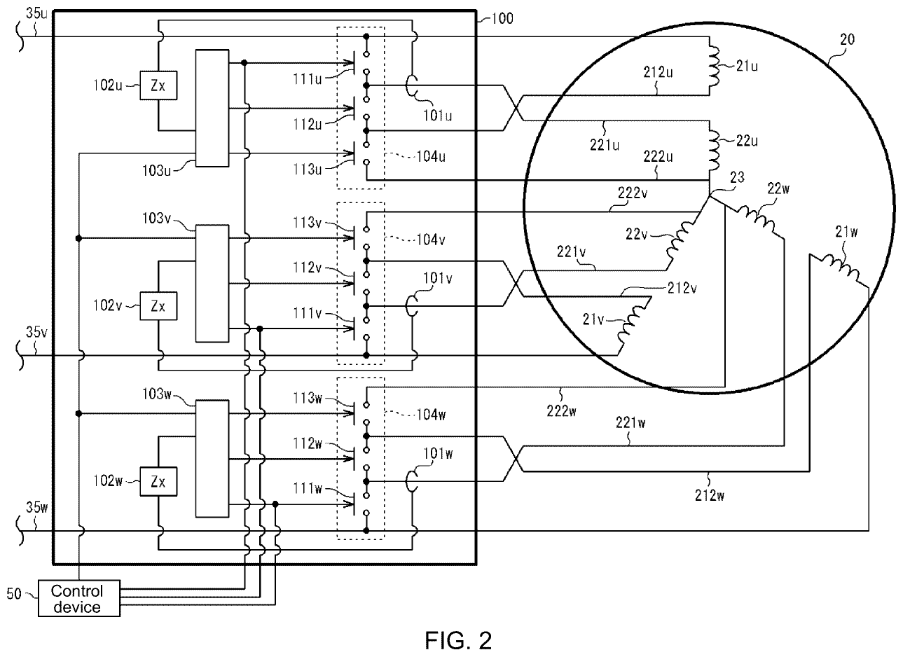

FIG. 2 is a circuit diagram showing an example of the configuration of the winding switching device according to the first embodiment. The motor 20 includes a plurality of windings 21u, 22u, 21v, 22v, 21w, and 22w. The windings 21u and 22u correspond to the U-phase, the windings 21v and 22v correspond to the V-phase, and the windings 21w and 22w correspond to the W-phase. However, the number of windings for each phase is not limited to two, and may be three or more. The windings 22u, 22v, and 22w are connected at a neutral point 23.

The winding switching device 100 switches the connection state of the windings 21u, 22u, 21v, 22v, 21w, and 22w for each phase between a series connection state and a parallel connection state. The winding switching device 100 includes current sensors 101u, 101v, and 101w, zero crossing detection circuits 102u, 102v, and 102w, control circuits 103u, 103v, and 103w, and switching circuits 104u, 104v, and 104w.

The zero crossing detection circuits 102u, 102v, and 102w detect zero crossing points of the measurement values of the current sensors 101u, 101v, and 101w. In a more specific example, the zero crossing detection circuits 102u, 102v, and 102w compare the output voltages from the current sensors 101u, 101v, and 101w with a zero voltage, and detect points in time when the output voltages from the current sensors 101u, 101v, and 101w coincide with the zero voltage as the zero crossing points. The zero voltage is an example of a reference voltage. The reference voltage is a voltage corresponding to the output voltages of the current sensors 101u, 101v, and 101w when the current flowing through the windings 21u, 22u, 21v, 22v, 21w, and 22w becomes zero, and is not limited to the zero voltage. The zero crossing detection circuits 102u, 102v, and 102w are examples of detection units. Note that the output voltages from the current sensors 101u, 101v, and 101w do not need to exactly match the zero voltage, and the same effect can be obtained also by detecting the points in time at which the output voltages from the current sensors 101u, 101v, and 101w become close to the zero voltage as the zero crossing points.

The switching circuits 104u, 104v, and 104w switch the connection state of the windings 21u, 22u, 21v, 22v, 21w, and 22w between a series connection state and a parallel connection state at the timing when the zero crossing detection circuits 102u, 102v, and 102w detect the zero crossing points. The switching circuits 104u, 104v, and 104w are examples of switching units. The series connection state is an example of a first connection state, and the parallel connection state is an example of a second connection state.

Hereinafter, the connection relationship between the winding switching device 100, the power line 35u, and the motor 20 will be described for the U-phase as a representative example. Since the same applies for the V-phase and the W-phase, description thereof is omitted.

The power line 35u is connected to one end of the winding 21u. A power line 212u extends from the other end of the winding 21u. A power line 221u extends from one end of the winding 22u, and a power line 222u extends from the other end.

The switching circuit 104u includes semiconductor relays 111u, 112u, and 113u. The semiconductor relays 111u, 112u, and 113u are, for example, IGBTs or power MOSFETs.

The power line 35u is led into the winding switching device 100. In the winding switching device 100, the power line 35u branches off at an intermediate point and is connected to a first terminal of the semiconductor relay 111u. A second terminal of the semiconductor relay 111u is connected to a first terminal of the semiconductor relay 112u. The power line 221u extending from the winding 22u is connected to a connection point between the second terminal of the semiconductor relay 111u and the first terminal of the semiconductor relay 112u.

A second terminal of the semiconductor relay 112u is connected to a first terminal of the semiconductor relay 113u. The power line 212u extending from the winding 21u is connected to a connection point between the second terminal of the semiconductor relay 112u and the first terminal of the semiconductor relay 113u. A second terminal of the semiconductor relay 113u is connected to the power line 222u extending from the winding 22u.

When the semiconductor relays 111u and 113u are in an off state and the semiconductor relay 112u is in an on state, the windings 21u and 22u are connected in series. When the semiconductor relays 111u and 113u are in an on state and the semiconductor relay 112u is in an off state, the windings 21u and 22u are connected in parallel.

Signal lines extending from the control circuit 103u are respectively connected to the gate terminals of the semiconductor relays 111u, 112u, and 113u.

The power lines 212u, 221u, and 222u extend from the motor 20 and are led into the winding switching device 100. A current sensor 101u is attached to the power line 221u. However, the current sensor 101u may be attached to the power line 35u, 212u, or 222u instead of the power line 221u. The current sensor 101u detects a U-phase current flowing through the power line 221u. The current sensor 101u is, for example, an ACCT that detects only the AC component of a current.

A signal line extending from the current sensor 101u is connected to the zero crossing detection circuit 102u. A signal line that transmits an output signal of the zero crossing detection circuit 102u (hereinafter referred to as a “zero crossing detection signal”) extends from the zero crossing detection circuit 102u to the control circuit 103u. Furthermore, a signal line extending from the control device 50 is connected to the control circuit 103u.

The zero crossing detection circuit 102u detects a zero crossing point of the measurement value of the winding current flowing through the power line 221u, which is measured by the current sensor 101u. The zero crossing detection circuit 102u is a comparator. For example, the inverting input of the comparator is set to a zero reference voltage, and the output signal of the current sensor 101u is applied to the non-inverting input. As a result, at the point in time when the AC signal output from the current sensor 101u crosses the zero reference voltage (zero crossing point), the output of the comparator changes from Low to High.

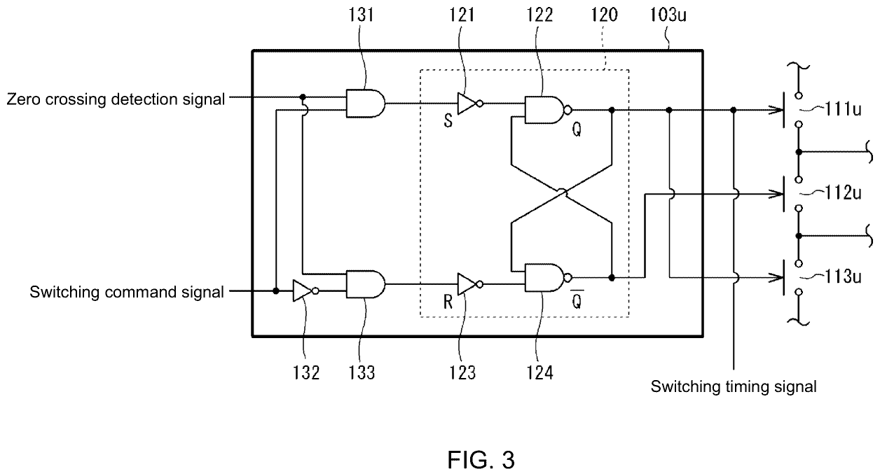

FIG. 3 is a circuit diagram showing an example of the configuration of the control circuit 103u. The control circuit 103u includes AND circuits 131 and 133, a NOT circuit 132, and a latch circuit 120. A signal line extending from the zero crossing detection circuit 102u is connected to a first input terminal of the AND circuit 131 and a first input terminal of the AND circuit 133. A signal line extending from the control device 50 is connected to a second input terminal of the AND circuit 131. Furthermore, the signal line from the control device 50 is connected to an input terminal of the NOT circuit 132. A signal line extending from the output terminal of the NOT circuit 132 is connected to a second input terminal of the AND circuit 133.

The latch circuit 120 is an RS flip-flop. The output terminal of the AND circuit 131 is connected to an input S (set) of the RS flip-flop 120. The output terminal of the AND circuit 133 is connected to an input R (reset) of the RS flip-flop 120. The RS flip-flop 120 includes two NOT circuits 121 and 123 and two NAND circuits 122 and 124. However, the RS flip-flop 120 may be constituted by two NOR circuits.

An output Q of the RS flip-flop 120 is connected to the gates of the semiconductor relays 111u and 113u. An output Q-bar of the RS flip-flop 120 is connected to the gate of the semiconductor relay 112u.

When the signal output from the output Q of the RS flip-flop 120 is Low and the signal output from the output Q-bar of the RS flip-flop 120 is High, the semiconductor relays 111u and 113u are in the off state and the semiconductor relay 112u is in the on state. That is, at this time, the windings 21u and 22u are connected in series. When the signal output from the output Q of the RS flip-flop 120 is High and the signal output from the output Q-bar of the RS flip-flop 120 is Low, the semiconductor relays 111u and 113u are in the on state and the semiconductor relay 112u is in the off state. That is, at this time, the windings 21u and 22u are connected in parallel. When the signal output from the output Q of the RS flip-flop 120 switches from Low to High and the signal output from the output Q-bar of the RS flip-flop 120 switches from High to Low, the semiconductor relays 111u and 113u switch from the off state to the on state, and the semiconductor relay 112u switches from the on state to the off state. That is, the windings 21u and 22u are switched from a series connection state to a parallel connection state. When the signal output from the output Q of the RS flip-flop 120 switches from High to Low and the signal output from the output Q-bar of the RS flip-flop 120 switches from Low to High, the semiconductor relays 111u and 113u switch from the on state to the off state, and the semiconductor relay 112u switches from the off state to the on state. That is, the windings 21u and 22u are switched from a parallel connection state to a series connection state.

Accordingly, the signal output from the output Q of the RS flip-flop 120 is a signal (switching timing signal) that indicates the switching timing for switching the connection state of the windings 21u and 22u. As shown in FIG. 2, a signal line extending from the control circuit 103u to the gate terminal of the semiconductor relay 111u branches off at an intermediate point, and the branched end is connected to the control device 50. A U-phase switching timing signal is input to the control device 50 via this signal line. Similarly, a signal line extending from the control circuit 103v to the gate terminal of the semiconductor relay 111v branches off at an intermediate point, and the branched end is connected to the control device 50. A V-phase switching timing signal is input to the control device 50 via this signal line. A signal line extending from the control circuit 103w to the gate terminal of the semiconductor relay 111w branches off at an intermediate point, and the branched end is connected to the control device 50. A W-phase switching timing signal is input to the control device 50 via this signal line.

### Zero Crossing Switching of Winding Switching Device

Next, the zero crossing switching of the winding switching device 100 will be described. The zero crossing switching is an operation for switching the connection state of the windings 21u, 22u, 21v, 22v, 21w, and 22w between a series connection state and a parallel connection state at the zero crossing points of the winding currents Iu, Iv, and Iw. Note that hereinafter, the switching operation of the connection states of the windings 21u and 22u for the U-phase will be described as a representative example. The V-phase and W-phase are similar, and therefore description thereof will be omitted.

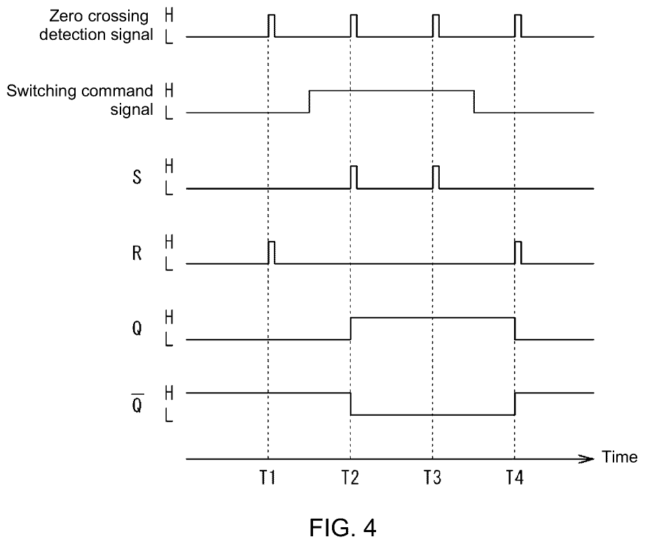

FIG. 4 is a timing chart showing an example of transition of the states of the signals of the winding switching device 100 according to the first embodiment.

The current sensor 101u measures the winding current Iu flowing through the power line 221u. The zero crossing detection circuit 102u detects the zero crossing point of the measurement value of the winding current Iu. That is, the zero crossing detection signal output from the zero crossing detection circuit 102u is Low when the winding current Iu is not zero, and is High at the point in time when the winding current Iu becomes zero. In FIG. 4, the zero crossing detection signal is normally Low and is High at times T1, T2, T3, and T4.

When the windings 21u, 22u, 21v, 22v, 21w, and 22w of the motor 20 are to be connected in series, the control device 50 sets the value of the switching command signal to Low, and when the windings 21u, 22u, 21v, 22v, 21w, and 22w are to be connected in parallel, the control device 50 sets the value of the switching command signal to High. In FIG. 4, the switching command signal is initially Low and changes to High at a point in time between times T1 and T2. The switching command signal changes to Low again at a point in time between times T3 and T4.

The zero crossing detection signal and the switching command signal are input to the AND circuit 131. The AND circuit 131 outputs Low when the zero crossing detection signal and the switching command signal are a combination of (Low, Low), (Low, High), or (High, Low). The AND circuit 131 outputs High when the zero crossing detection signal and the switching command signal are a combination of (High, High). That is, Low is normally input to S of the RS flip-flop 120, and High is input when a zero crossing point of the winding current Iu is detected and a parallel connection command for the windings 21u, 22u, 21v, 22v, 21w, and 22w is given. In FIG. 4, at times T2 and T3, the input signal of S is High.

The zero crossing detection signal and an inverted signal of the switching command signal (the output signal of the NOT circuit 132) are input to the AND circuit 133. The AND circuit 133 outputs Low when the zero crossing detection signal and the switching command signal are a combination of (Low, Low), (Low, High), or (High, High). The AND circuit 133 outputs High when the zero crossing detection signal and the switching command signal are a combination of (High, Low). That is, Low is normally input to R of the RS flip-flop 120, and High is input when a zero crossing point of the winding current Iu is detected and a series connection command for the windings 21u, 22u, 21v, 22v, 21w, and 22w is given. In FIG. 4, the input signal of R is High at times T1 and T4.

The RS flip-flop 120 holds the previous output values of Q and Q-bar when the inputs S and R are Low and Low. In the RS flip-flop 120, when the inputs S and R are Low and High, Q and Q-bar output Low and High, and when the inputs S and R are High and Low, Q and Q-bar output High and Low. In the RS flip-flop 120, a combination in which the inputs S and R are High and High is prohibited.

In the example of FIG. 4, Q is Low and Q-bar is High until time T2. Accordingly, until time T2, the semiconductor relays 111u and 113u are in the off state, and the semiconductor relay 112u is in the on state. For this reason, the windings 21u and 22u are connected in series.

When time T2 arrives, Q changes from Low to High, and Q-bar changes from High to Low. Accordingly, the semiconductor relays 111u and 113u change from the off state to the on state, and the semiconductor relay 112u changes from the on state to the off state. For this reason, the connection state of the windings 21u and 22u switches from the series connection state to the parallel connection state.

From time T2 to T4, Q is High and Q-bar is Low. Therefore, from time T2 to time T4, the semiconductor relays 111u and 113u maintain the on state, and the semiconductor relay 112u maintains the off state. For this reason, the windings 21u and 22u are maintained in the parallel connection state.

When time T4 arrives, Q changes from High to Low, and Q-bar changes from Low to High. Accordingly, the semiconductor relays 111u and 113u change from the on state to the off state, and the semiconductor relay 112u changes from the off state to the on state. For this reason, the connection state of the windings 21u and 22u switches from the parallel connection state to the series connection state.

From time T4 onwards, Q is Low and Q-bar is High. Accordingly, until time T2, the semiconductor relays 111u and 113u maintain the off state, and the semiconductor relay 112u maintains the on state. For this reason, the windings 21u and 22u are maintained in the series connection state.

As described above, the connection state of the windings 21u, 22u, 21v, 22v, 21w, and 22w can be switched between the series connection state and the parallel connection state at the timing of the zero crossing points of the winding currents Iu, Iv, and Iw. Accordingly, the occurrence of a surge voltage is suppressed. Furthermore, there is no need for complex processing to specify the period during which the winding currents Iu, Iv, and Iw are less than or equal to a predetermined value, and the winding switching device 100 can be formed without using a processor such as a CPU, FPGA, or ASIC.

### Hardware Configuration of Control Device

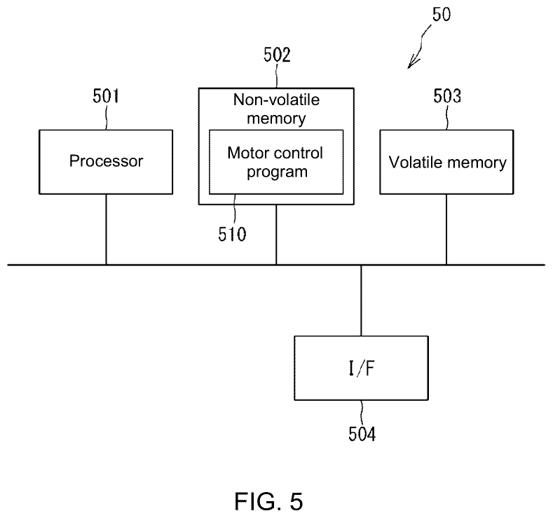

FIG. 5 is a block diagram illustrating an example of a hardware configuration of the control device according to the first embodiment. The control device 50 includes a processor 501, a non-volatile memory 502, a volatile memory 503, and an interface (I/F) 504.

The volatile memory 503 is a semiconductor memory such as a static random access memory (SRAM) or a dynamic random access memory (DRAM). The non-volatile memory 502 is, for example, a flash memory, a hard disk, or a Read Only Memory (ROM). The non-volatile memory 502 stores a motor control program 510, which is a computer program, and data used for executing the motor control program 510. Each function of the control device 50 is realized by the processor 501 executing the motor control program 510. The motor control program 510 can be stored in a recording medium such as a flash memory, a ROM, or a CD-ROM. The processor 501 controls the power converter 30 and the winding switching device 100 according to the motor control program 510.

The processor 501 is, for example, a central processing unit (CPU). However, the processor 501 is not limited to a CPU. The processor 501 may be a graphics processing unit (GPU). The processor 501 is, for example, a multi-core processor. The processor 501 may be a single-core processor. The processor 501 may be, for example, an application specific integrated circuit (ASIC), or a programmable logic device such as a gate array or a field programmable gate array (FPGA). In this case, the ASIC or programmable logic device is configured to be able to execute the same processing as the motor control program 510.

The I/F 504 is connected to the winding switching device 100 and the power converter 30. The I/F 504 is, for example, an input/output interface or a communication interface. For example, the I/F 504 is connected to the current sensors 33u, 33v, and 33w provided in the power converter 30, and can acquire the current value of the U-phase current Iu, the current value of the V-phase current Iv, and the current value of the W-phase current Iw. For example, the I/F 504 is connected to each of the switches 31u, 32u, 31v, 32v, 31w, and 32w of the power converter 30, and can control the switching on and off of the switches 31u, 32u, 31v, 32v, 31w, and 32w. For example, the I/F 504 is connected to the control circuits 103u, 103v, and 103w of the winding switching device 100, and can output a switching command signal to the control circuits 103u, 103v, and 103w.

### Functions of Control Device

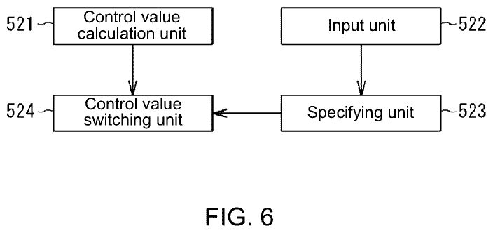

FIG. 6 is a functional block diagram showing an example of functions of the control device according to the first embodiment.

When the processor 501 executes the motor control program 510, the control device 50 executes the functions of a control value calculation unit 521, an input unit 522, a specifying unit 523, and a control value switching unit 524.

The control value calculation unit 521 calculates a control value for controlling the motor 20.

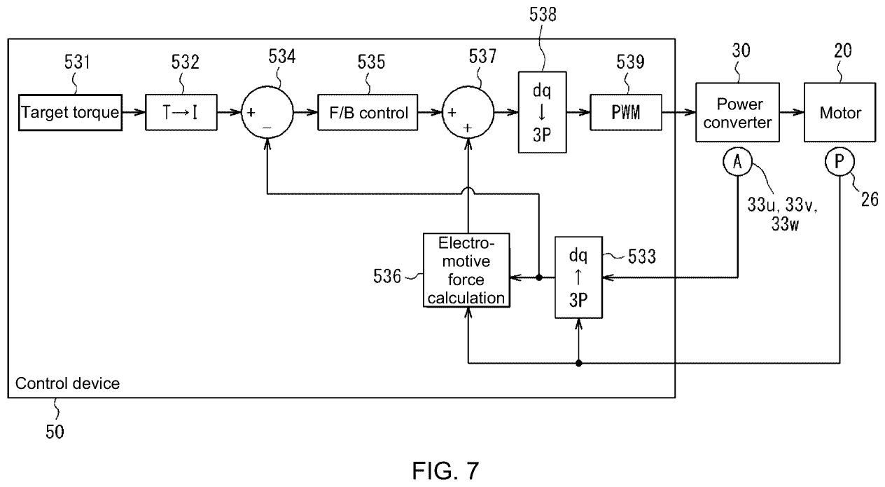

FIG. 7 is a control block diagram showing a control system of a motor of a control device according to the first embodiment. Hereinafter, the calculation of control values will be described with reference to FIG. 7.

The control device 50 sets a target torque 531 for the motor 20. The target torque 531 is calculated from, for example, a target speed or the like of the vehicle.

The target torque 531 is input to a torque-current conversion unit 532. The torque-current conversion unit 532 converts the target torque 531 into a target current. The conversion from the target torque 531 to the target current is performed based on the output characteristics of the motor 20 stored in advance in the control device 50. For example, the output characteristics when the windings 21u, 22u, 21v, 22v, 21w, and 22w are in the series connection state are different from the output characteristics when the windings 21u, 22u, 21v, 22v, 21w, and 22w are in the parallel connection state. For example, the non-volatile memory 502 of the control device 50 stores two types of output characteristics, namely the output characteristics when the windings 21u, 22u, 21v, 22v, 21w, and 22w are in the series connection state, and the output characteristics when the windings 21u, 22u, 21v, 22v, 21w, and 22w are in the parallel connection state. The torque-current conversion unit 532 determines a target current in accordance with output characteristics corresponding to the connection state of the windings 21u, 22u, 21v, 22v, 21w, and 22w at that point in time. The target current obtained by the torque current conversion unit 532 is a current value in the dq coordinate system (hereinafter also referred to as a “dq current value”; a voltage value in the dq coordinate system is also referred to as a “dq voltage value”).

The detection values of the current sensors 33u, 33v, and 33w and the detection value of the position sensor 26 are input to a current conversion unit 533. The current conversion unit 533 converts the current value of each phase of the three-phase alternating current into a dq current value. The current conversion unit 533 outputs the detection values of the current sensors 33u, 33v, and 33w, that is, the dq current values corresponding to the winding currents Iu, Iv, and Iw.

At a summing point 534, the difference between the target current output from the torque current conversion unit 532 and the winding current output from the current conversion unit 533 is calculated. The calculated difference is input to an F/B control unit 535.

The F/B control unit 535 calculates a feedback gain based on the difference between the input target current and the winding current. For example, the correspondence relationship between the difference and the feedback gain is determined in advance. For example, two types of correspondence relationships are determined, namely a correspondence relationship when the windings 21u, 22u, 21v, 22v, 21w, and 22w are in the series connection state, and a correspondence relationship when the windings 21u, 22u, 21v, 22v, 21w, and 22w are in the parallel connection state. The F/B control unit 535 determines a feedback gain from the difference according to the correspondence relationship corresponding to the connection state of the windings 21u, 22u, 21v, 22v, 21w, and 22w at that time. The feedback gain is a portion of the drive voltage of the motor 20.

The F/B control unit 535 determines the feedback gain according to a predetermined control method. For example, the F/B control unit 535 can determine the feedback gain according to any one of P control (proportional control), PI control (proportional integral control), PD control (proportional differential control), and PID control (proportional integral differential control). The above-mentioned correspondence relationship is determined according to such a control method.

The winding current output from the current conversion unit 533 and the detection value of the position sensor 26 are input to an electromotive force calculation unit 536. Based on the winding current and the rotational speed of the motor 20, the electromotive force calculation unit 536 calculates a control component obtained based on the induced voltage generated in the motor 20, such as a control component for decoupling control of the alternating current of the motor 20, mutual inductance between the d-axis and q-axis, and the like. The induced voltage differs between when the windings 21u, 22u, 21v, 22v, 21w, and 22w are in the series connection state and when they are in the parallel connection state. Accordingly, the electromotive force calculation unit 536 calculates a control component obtained based on the induced voltage corresponding to the connection state of the windings 21u, 22u, 21v, 22v, 21w, and 22w at that time.

The decoupling control will be described hereinafter.

A state equation (differential equation) of an eternal magnet synchronous motor in the d-q coordinate system is expressed by Formula (1).

$$\begin{matrix}[ Math . 1 ] & \\ p [ \begin{matrix}{i}_{d} \\ {i}_{q}\end{matrix} ] = [ \begin{matrix}- \frac{{R}_{a}}{{L}_{d}} & \frac{ω {L}_{q}}{{L}_{d}} \\ - \frac{ω {L}_{d}}{{L}_{q}} & - \frac{{R}_{a}}{{L}_{q}}\end{matrix} ] [ \begin{matrix}{i}_{d} \\ {i}_{q}\end{matrix} ] + [ \begin{matrix}\frac{1}{{L}_{d}} & 0 \\ 0 & \frac{1}{{L}_{q}}\end{matrix} ] [ \begin{matrix}{v}_{d} \\ {v}_{q}\end{matrix} ] - [ \begin{matrix}0 \\ \frac{{ωΨ}_{a}}{{L}_{q}}\end{matrix} ] & ( 1 )\end{matrix}$$

$${pi}_{a} = {A}_{e} {i}_{a} + {B}_{e} {v}_{a} + {d}_{e} \qquad ( 1 ’ )$$

Here, ia=[id,iq]^{T} is the armature current (winding current), va=[vd,vq]^{T} is the armature voltage, ω is the angular velocity of the motor, Ψa is the magnet magnetic flux, Ra is the winding resistance, Ld and Lq are the winding inductances, and p is the differential symbol.

In decoupling control, the influence of interference terms between the d and q axes due to induced electromotive force is eliminated. Specifically, the d-axis and q-axis voltages are corrected as shown in the following Formula (2).

$$\begin{matrix}[ Math . 2 ] & \\ \begin{matrix}{v}_{d} = {v}_{d}^{′} + {v}_{od} = {v}_{d}^{′} - ω {L}_{q} {i}_{q} \\ {v}_{q} = {v}_{q}^{′} + {v}_{oq} = {v}_{q}^{′} + ω ( {Ψ}_{a} + {L}_{d} {i}_{d} )\end{matrix} \} & ( 2 )\end{matrix}$$

Here, vod is the d-axis component of the induced electromotive force, and voq is the q-axis component of the induced electromotive force.

By substituting Formula (2) into Formula (1), the following Formula (3) in which v′a=[v′d,v′q] is a new input is derived.

$$\begin{matrix}[ Math . 3 ] & \\ p [ \begin{matrix}{i}_{d} \\ {i}_{q}\end{matrix} ] = [ \begin{matrix}- \frac{{R}_{a}}{{L}_{d}} & 0 \\ 0 & - \frac{{R}_{a}}{{L}_{q}}\end{matrix} ] [ \begin{matrix}{i}_{d} \\ {i}_{q}\end{matrix} ] + [ \begin{matrix}\frac{1}{{L}_{d}} & 0 \\ 0 & \frac{1}{{L}_{q}}\end{matrix} ] [ \begin{matrix}{v}_{d}^{′} \\ {v}_{q}^{′}\end{matrix} ] & ( 3 )\end{matrix}$$

$${pi}_{a} = {A}_{e}^{′} {i}_{a} + {B}_{e} {v}_{a}^{′} \qquad ( 3 ’ )$$

From Formula (3), it can be understood that the d-axis and q-axis can be decoupled and a disturbance de can be cancelled.

The feedback gain output from the F/B control unit 535 and the control component output from the electromotive force calculation unit 536 are input to a summing point 537. The summing point 537 adds the feedback gain output from the F/B control unit 535 and the control component output from the electromotive force calculation unit 536 to calculate a voltage value to be applied to the motor 20 (hereinafter also referred to as a “control voltage value”). The control voltage value is an example of a “control value”.

The control voltage value is input to a voltage conversion unit 538. The voltage conversion unit 538 converts the dq voltage value into a three-phase AC voltage.

The control voltage value of the three-phase AC voltage output from the voltage conversion unit 538 is input to a PWM unit 539. The PWM unit 539 determines a duty ratio corresponding to the input control voltage value, and generates PWM signals for driving each of the switches 31u, 32u, 31v, 32v, 31w, and 32w of the power converter 30 according to the determined duty ratio. The PWM unit 539 outputs the generated PWM signal to each of the switches 31u, 32u, 31v, 32v, 31w, and 32w.

Returning to FIG. 6, the input unit 522 receives a switching timing signal that is output by the winding switching device 100 at the timing when the winding switching device 100 executes zero crossing switching. That is, the input unit 522 receives switching timing signals output from the control circuits 103u, 103v, and 103w of the winding switching device 100 to the gate terminals of the semiconductor relays 111u, 111v, and 111w, respectively.

The specifying unit 523 specifies the switching timing at which zero crossing switching for switching the connection state of the windings 21u, 22u, 21v, 22v, 21w, and 22w from the series connection state to the parallel connection state or from the parallel connection state to the series connection state at the zero crossing points of the winding currents Iu, Iv, and Iw is executed. In a specific example, the specifying unit 523 specifies the switching timing based on the input of the switching timing signal in the input unit 522. For example, the specifying unit 523 can specify each of the switching timing in the U-phase, the switching timing in the V-phase, and the switching timing in the W-phase.

The control value switching unit 524 switches the control value for controlling the motor 20 between a control value to be used in the series connection state (hereinafter also referred to as a “series connection control value”) and a control value to be used in the parallel connection state (hereinafter also referred to as a “parallel connection control value”) based on the switching timing specified by the specifying unit 523.

FIG. 7 will be referred to. For example, when zero crossing switching is about to be executed, the torque-current conversion unit 532 determines both the target current in the series connection state and the target current in the parallel connection state based on the target torque 531. In a specific example, when a gear shift instruction is given to the control device 50 from a gear shift instruction device (not shown), the control device 50 determines that zero crossing switching is to be executed in response to the gear shift instruction. In this case, it can be judged that zero crossing switching is about to be executed. If it is determined to that zero crossing switching is to be executed, the torque-current conversion unit 532 can determine both the target current in the series connection state and the target current in the parallel connection state.

The torque-current conversion unit 532 inputs both the target current in the series connection state and the target current in the parallel connection state to the F/B control unit 535. For example, if it is determined that zero crossing switching is to be executed, the F/B control unit 535 determines both the feedback gain to be used in the series connection state and the feedback gain to be used in the parallel connection state.

For example, if it is determined that zero crossing switching is to be executed, the electromotive force calculation unit 536 calculates both a control component obtained based on the induced voltage in the series connection state and a control component obtained based on the induced voltage in the parallel connection state.

The F/B control unit 535 outputs both the feedback gain to be used in the series connection state and the feedback gain to be used in the parallel connection state to the summing point 537. The electromotive force calculation unit 536 outputs both a control component obtained based on the induced voltage in the series connection state and a control component obtained based on the induced voltage in the parallel connection state to the summing point. The summing point 537 adds the feedback gain to be used in the series connection state and the control component obtained based on the induced voltage in the series connection state to calculate a control voltage value in the series connection state. At the same time, the summing point 537 adds the feedback gain to be used in the parallel connection state and the control component obtained based on the induced voltage in the parallel connection state to calculate a control voltage value in the parallel connection state.

The control voltage value in the series connection state and the control voltage value in the parallel connection state are each input to a voltage conversion unit 538. The voltage conversion unit 538 converts the control voltage value in the series connection state from a dq voltage value to a three-phase AC voltage, and converts the control voltage value in the parallel connection state from a dq voltage value to a three-phase AC voltage.

Referring to FIG. 6, when switching from the series connection state to the parallel connection state is performed through zero crossing switching, the control value switching unit 524 switches the control voltage value output from the voltage conversion unit 538 from the control voltage value in the series connection state to the control voltage value in the parallel connection state at the switching timing specified by the specifying unit 523. When switching from the parallel connection state to the series connection state is performed through zero crossing switching, the control value switching unit 524 switches the control voltage value output from the voltage conversion unit 538 from the control voltage value in the parallel connection state to the control voltage value in the series connection state at the switching timing specified by the specifying unit 523.

In a specific example, when switching from the series connection state to the parallel connection state is performed through zero crossing switching, the control value switching unit 524 switches the control voltage value for the U-phase output from the voltage conversion unit 538 at the U-phase switching timing from the control voltage value in the series connection state to the control voltage value in the parallel connection state. Similarly, at the V-phase switching timing, the control value switching unit 524 switches the control voltage value for the V-phase output from the voltage conversion unit 538 from the control voltage value in the series connection state to the control voltage value in the parallel connection state. At the W-phase switching timing, the control value switching unit 524 switches the control voltage value for the W-phase output from the voltage conversion unit 538 from the control voltage value in the series connection state to the control voltage value in the parallel connection state.

When switching from the parallel connection state to the series connection state is performed through zero crossing switching, the control value switching unit 524 switches the control voltage value for the U-phase output from the voltage conversion unit 538 at the U-phase switching timing from the control voltage value in the parallel connection state to the control voltage value in the series connection state. Similarly, at the V-phase switching timing, the control value switching unit 524 switches the control voltage value for the V-phase output from the voltage conversion unit 538 from the control voltage value in the parallel connection state to the control voltage value in the series connection state. At the W-phase switching timing, the control value switching unit 524 switches the control voltage value for the W-phase output from the voltage conversion unit 538 from the control voltage value in the parallel connection state to the control voltage value in the series connection state.

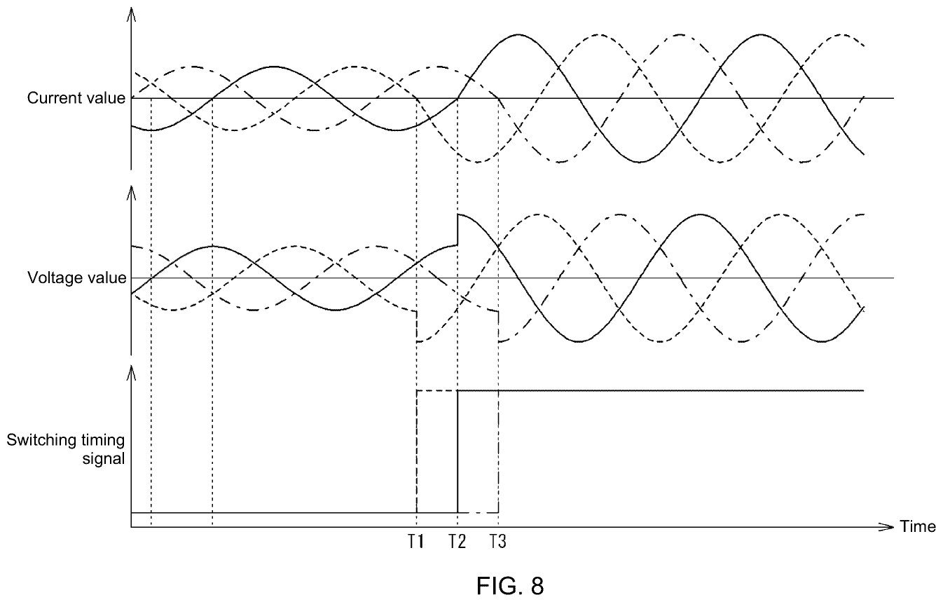

FIG. 8 is a graph showing examples of the winding voltages, winding currents, and switching timing signals for the U-phase, V-phase, and W-phase when the control voltage value for each phase is switched at the timing of zero crossing switching. In FIG. 8, starting from the top, the vertical axis indicates a current value, a voltage value, and a switching timing signal, and the horizontal axis indicates time.

At time T1, the U-phase switching timing signal changes from Low to High. In response to this, the U-phase winding voltage, that is, the control voltage value, is switched. The winding current lags behind the winding voltage by 90 degrees. The amplitude of the U-phase winding current changes at time T1. Similarly, at time T2, the V-phase switching timing signal changes from Low to High. In response to this, the V-phase winding voltage, that is, the control voltage value, is switched. The amplitude of the V-phase winding current changes at time T2. At time T3, the W-phase switching timing signal changes from Low to High. In response to this, the W-phase winding voltage, that is, the control voltage value, is switched. The amplitude of the W-phase winding current changes at time T3.

In this manner, by switching the control voltage value in accordance with the timing of the zero crossing switching, it is possible to suppress the occurrence of a surge voltage.

### Operations of Control Device

Next, operations of the control device 50 will be described. The control device 50 executes motor control processing by the processor 501 executing a motor control program 510.

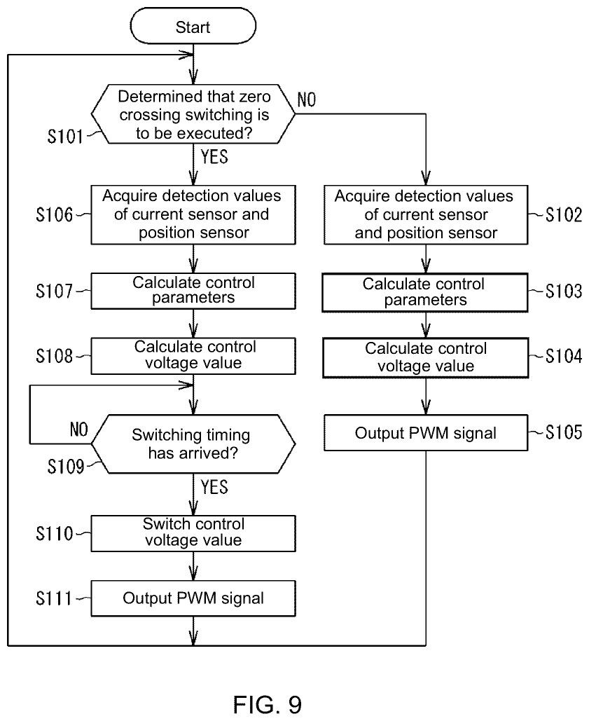

FIG. 9 is a flowchart showing an example of motor control processing performed by the control device according to the first embodiment.

For example, when a gear shift instruction is given to the control device 50, the processor 501 judges that zero crossing switching is to be executed. The processor 501 determines whether or not it has been determined that zero crossing switching is to be executed (step S101).

If it has not been determined that zero crossing switching is to be executed (NO in step S101), the processor 501 acquires the detection values output from the current sensors 33u, 33v, and 33w and the detection value output from the position sensor 26 (step S102). The processor 501 calculates the rotation speed of the motor 20 based on the detection value from the position sensor 26.

The processor 501 calculates control parameters corresponding to the connection states of the windings 21u, 22u, 21v, 22v, 21w, and 22w at that time based on the acquired current values of the winding currents Iu, Iv, Iw and the rotational speed of the motor 20 (step S103). The control parameters include a control component obtained based on a target current, a feedback gain, and an induced voltage.

The processor 501 calculates control voltage values corresponding to the connection states of the windings 21u, 22u, 21v, 22v, 21w, and 22w at that time based on the calculated control parameters (step S104).

The processor 501 determines a duty ratio based on the calculated control voltage value, and outputs a PWM signal having the determined duty ratio (step S105). The switches 31u, 32u, 31v, 32v, 31w, and 32w are driven in accordance with the PWM signal, and the motor 20 is supplied with the winding currents Iu, Iv, and Iw. After step S105, the processor 501 returns to step S101.

If it has been determined that zero crossing switching is to be executed (YES in step S101), the processor 501 acquires the detection values output from the current sensors 33u, 33v, and 33w and the detection value output from the position sensor 26 (step S106). The processor 501 calculates the rotation speed of the motor 20 based on the detection value from the position sensor 26.

The processor 501 calculates the control parameter corresponding to the series state of the windings 21u, 22u, 21v, 22v, 21w, and 22w and the control parameter corresponding to the parallel state based on the acquired current values of the winding currents Iu, Iv, and Iw and the rotational speed of the motor 20 (step S107). That is, the processor 501 calculates a target current for each of the series connection state and the parallel connection state, a feedback gain for each of the series connection state and the parallel connection state, and a control component obtained based on the induced voltage for each of the series connection state and the parallel connection state.

The processor 501 calculates the control voltage value in the series connection state and the control voltage value in the parallel connection state based on the calculated control parameters (step S108).

In the first embodiment, the winding switching device 100 outputs a switching timing signal to the control device 50. The processor 501 specifies the switching timing based on the switching timing signal.

The processor 501 judges whether or not the switching timing has arrived (step S109). If the switching timing has not arrived (NO in step S109), the processor 501 executes step S109 again.

If the switching timing has arrived (YES in step S109), the processor 501 switches the control voltage value used to generate the PWM signal (step S110). That is, when the series connection state is switched to the parallel connection state through zero crossing switching, the processor 501 switches from the control voltage value in the series connection state to the control voltage value in the parallel connection state. When the parallel connection state is switched to the series connection state through zero crossing switching, the processor 501 switches from the control voltage value in the parallel connection state to the control voltage value in the series connection state.

The processor 501 determines a duty ratio based on the calculated control voltage value, and outputs a PWM signal having the determined duty ratio (step S111). The switches 31u, 32u, 31v, 32v, 31w, and 32w are driven in accordance with the PWM signal, and the motor 20 is supplied with the winding currents Iu, Iv, and Iw. After step S111, the processor 501 returns to step S101.

### Second Embodiment

The winding switching device of the second embodiment switches the connection state of a plurality of windings of a motor between a full connection state in which all of the plurality of windings are connected, and a partial connection state in which some of the plurality of windings are connected.

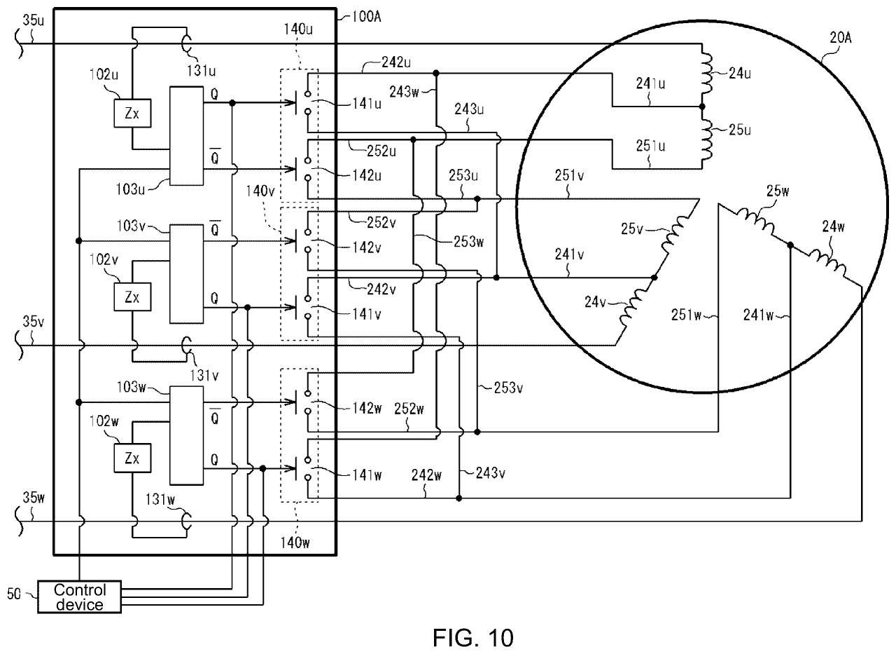

FIG. 10 is a circuit diagram showing an example of a configuration of a winding switching device according to a second embodiment. A motor 20A includes a plurality of windings 24u, 25u, 24v, 25v, 24w, and 25w. The windings 24u and 25u correspond to a U-phase, the windings 24v and 25v correspond to a V-phase, and the windings 24w and 25w correspond to a W-phase. However, the number of windings for each phase is not limited to two, and may be three or more.

A winding switching device 100A switches the connection state of the windings 24u, 25u, 24v, 25v, 24w, and 25w for each phase between a full connection state and a partial connection state. The winding switching device 100A includes current sensors 131u, 131v, and 131w, zero crossing detection circuits 102u, 102v, and 102w, control circuits 103u, 103v, and 103w, and switching circuits 140u, 140v, and 140w.

The zero crossing detection circuits 102u, 102v, and 102w detect zero crossing points of the measurement values of the current sensors 131u, 131v, and 131w. The configuration of the zero crossing detection circuits 102u, 102v, and 102w is similar to that of the first embodiment, and therefore description thereof is omitted.

The switching circuits 140u, 140v, 140w switch the connection state of the windings 24u, 25u, 24v, 25v, 24w, 25w between the full connection state and the partial connection state when the zero crossing detection circuits 102u, 102v, and 102w detect a zero crossing point. The switching circuits 140u, 140v, and 140w are an example of a switching unit. The full connection state is an example of a first connection state, and the partial connection state is an example of a second connected state.

A power line 35u is connected to one end of the winding 24u. The other end of the winding 24u and one end of the winding 25u are connected to each other, and a power line 241u extends from an intermediate point between the windings 24u and 25u. The power line 241u branches into power lines 242u and 243w. A power line 251u extends from the other end of the winding 25u. The power line 251u branches into power lines 252u and 253w.

A power line 35v is connected to one end of the winding 24v. The other end of the winding 24v and the one end of the winding 25v are connected to each other, and a power line 241v extends from an intermediate point between the windings 24v and 25v. The power line 241v branches into power lines 242v and 243u. A power line 251v extends from the other end of the winding 25v. The power line 251v branches into power lines 252v and 253u.

A power line 35w is connected to one end of the winding 24w. The other end of the winding 24w and one end of the winding 25w are connected to each other, and a power line 241w extends from an intermediate point between the windings 24w and 25w. The power line 241w branches into power lines 242w and 243v. A power line 251w extends from the other end of the winding 25w. The power line 251w branches into power lines 252w and 253v.

The switching circuit 140u includes semiconductor relays 141u and 142u. The switching circuit 140v includes semiconductor relays 141v and 142v. The switching circuit 140w includes semiconductor relays 141w and 142w. The semiconductor relays 141u, 142u, 141v, 142v, 141w, and 142w are, for example, IGBTs or power MOSFETs.

In the switching circuit 140u, a first terminal of the semiconductor relay 141u is connected to the power line 242u, and a second terminal of the semiconductor relay 141u is connected to the power line 243u. A first terminal of the semiconductor relay 142u is connected to the power line 252u, and a second terminal of the semiconductor relay 142u is connected to the power line 253u. The connection relationships of the switching circuits 140v and 140w are similar to that of the switching circuit 140u, and therefore description thereof is omitted.

When the semiconductor relays 141u, 141v, and 141w are in the off state and the semiconductor relays 142u, 142v, and 142w are in the on state, the full connection state is entered in which all of the windings 24u, 25u, 24v, 25v, 24w, and 25w are connected. When the semiconductor relays 141u, 141v, and 141w are in the on state and the semiconductor relays 142u, 142v, and 142w are in the off state, the partial connection state is entered in which only the windings 24u, 24v, and 24w are connected among the windings 24u, 25u, 24v, 25v, 24w, and 25w.

The power line 35u is led into the winding switching device 100A. The current sensor 131u is attached to the power line 35u. The current sensor 131u detects a U-phase current flowing through the power line 35u. The current sensor 131u is, for example, an ACCT that detects only the AC component of a current. A signal line extending from the current sensor 131u is connected to the zero crossing detection circuit 102u. The same applies for the V-phase and the W-phase as well.

An output Q of an RS flip-flop 120 of the control circuit 103u is connected to the gate of the semiconductor relay 141u. An output Q-bar of the RS flip-flop 120 is connected to the gate of the semiconductor relay 142u. The same applies for the V-phase and the W-phase as well.

Other configurations of the winding switching device 100A according to the second embodiment are similar to those of the winding switching device 100 according to the first embodiment, and therefore identical components are denoted by identical reference numerals and description thereof is omitted.

In the second embodiment, the control device 50 sets the value of the switching command signal to Low when the windings 24u, 25u, 24v, 25v, 24w, and 25w of the motor 20 are to be put in the full connection state, and sets the value of the switching command signal to High when the windings 24u, 25u, 24v, 25v, 24w, and 25w are to be put in the partial connection state.

When the windings are in the full connection state, the output Q becomes Low and the output Q-bar becomes High at the timing when the zero crossing detection signal and the switching command signal both become High. Accordingly, the semiconductor relay 141u changes from the on state to the off state, and the semiconductor relay 142u changes from the off state to the on state. The same applies for the V-phase and the W-phase as well. For this reason, the connection state of the windings 24u, 25u, 24v, 25v, 24w, and 25w is switched from a full connection state to a partial connection state.

When the windings are in the partial connection state, the zero crossing detection signal becomes High and the switching command signal becomes Low, and at that timing, the output Q becomes High and the output Q-bar becomes Low. Accordingly, the semiconductor relay 141u changes from the off state to the on state, and the semiconductor relay 142u changes from the on state to the off state. The same applies for the V-phase and the W-phase as well. For this reason, the connection state of the windings 24u, 25u, 24v, 25v, 24w, and 25w is switched from the partial connection state to the full connection state.

As described above, the connection state of the windings 21u, 22u, 21v, 22v, 21w, and 22w can be switched between the full connection state and the partial connection state at the timing of the zero crossing points of the winding currents Iu, Iv, and Iw.

The signal output from the output Q of the RS flip-flop 120 is a signal (switching timing signal) that indicates the timing for switching the connection state of the windings 24u and 25u. As shown in FIG. 10, a signal line extending from the control circuit 103u to the gate terminal of the semiconductor relay 141u branches off at an intermediate point, and the branched end is connected to the control device 50. A U-phase switching timing signal is input to the control device 50 via this signal line. Similarly, a signal line extending from the control circuit 103v to the gate terminal of the semiconductor relay 141v branches off at an intermediate point, and the branched end is connected to the control device 50. A V-phase switching timing signal is input to the control device 50 via this signal line. A signal line extending from the control circuit 103w to the gate terminal of the semiconductor relay 141w branches off at an intermediate point, and the branched end is connected to the control device 50. A W-phase switching timing signal is input to the control device 50 via this signal line.

The configurations and operations of the power converter 30 and the control device 50 according to the second embodiment are similar to those of the power converter 30 and the control device 50 according to the first embodiment, and therefore description thereof is omitted.

### Third Embodiment

The specifying unit 523 of the control device 50 according to the third embodiment detects the zero crossing points of the winding currents Iu, Iv, and Iw, and specifies the switching timing based on the detected zero crossing points. For example, the specifying unit 523 can specify the waveforms of the winding currents Iu, Iv, Iw from the chronological detection values of the current sensors 33u, 33v, 33w, and detect the zero crossing points in each of the U-phase, V-phase, and W-phase.

In a specific example, the specifying unit 523 can estimate that the next zero crossing point to arrive after the switching command signal is input to the winding switching device 100 is the switching timing. For example, the specifying unit 523 can estimate the switching timing for each of the U-phase, V-phase, and W-phase.

In the third embodiment, the input unit 522 receives detection values of the current sensors 33u, 33v, and 33w from the winding switching device 100 instead of a switching timing signal. The specifying unit 523 detects the zero crossing points of the winding currents Iu, Iv, and Iw based on the detection values of the current sensors 33u, 33v, and 33w input to the input unit 522.

Other functions of the control device 50 according to the third embodiment are similar to those of the control device 50 according to the first embodiment, and therefore description thereof is omitted. Other configurations of the winding switching system according to the third embodiment are similar to those of the winding switching system 10 according to the first embodiment, and description thereof is omitted.

### Fourth Embodiment

The control value switching unit 524 of the control device 50 according to the fourth embodiment gradually changes the control voltage value between the control voltage value in the series connection state and the control voltage value in the parallel connection state. That is, when the series connection state is switched to the parallel connection state through zero crossing switching, the control value switching unit 524 gradually changes from the control voltage value in the series connection state to the control voltage value in the parallel connection state. When the parallel connection state is to be switched to the series connection state through zero crossing switching, the control value switching unit 524 gradually changes from the control voltage value in the parallel connection state to the control voltage value in the series connection state.

For example, the control value switching unit 524 can change from the control voltage value in the series connection state to the control voltage value in the parallel connection state in a ramp shape, and can change from the control voltage value in the parallel connection state to the control voltage value in the series connection state in a ramp shape. This allows the control voltage value to change gradually, making it possible to more reliably suppress the occurrence of a surge voltage.

Here, gradually changing the control voltage value includes changing the control voltage value in a stepwise manner. That is, gradually changing the control voltage value is not limited to smoothly changing the control voltage value over time. For example, the control voltage value may be changed in multiple steps or discretely.

### SUPPLEMENTARY NOTE

The embodiments disclosed herein are exemplary in all respects and are not restrictive. The scope of the present disclosure is indicated not by the above-described embodiments, but by the claims, and encompasses meanings equivalent to the claims and all modifications within the scope thereof.

1-9. (canceled)

10. A control device for controlling an AC motor capable of switching a connection state of a plurality of windings from a first connection state to a second connection state, comprising:
a specifying unit configured to specify a switching timing at which zero crossing switching for switching the connection state of the plurality of windings of the AC motor from the first connection state to the second connection state at a zero crossing point of current flowing through the windings is executed; and
a control value switching unit configured to switch a control voltage value, which is a voltage value to be applied to the AC motor from a first control voltage value to be used in the first connection state to a second control voltage value to be used in the second connection state, based on the switching timing specified by the specifying unit.

11. The control device according to claim 10, further including;
an input unit configured to receive a switching timing signal output by a winding switching device configured to switch the connection state of the plurality of windings at a timing when the zero crossing switching is executed,
wherein the specifying unit specifies the switching timing based on input of the switching timing signal in the input unit.

12. The control device according to claim 10, wherein the specifying unit detects a zero crossing point of the current flowing through the windings, and specifies the switching timing based on the detected zero crossing point.

13. The control device according to claim 12, wherein the specifying unit estimates that the next zero crossing point that is to arrive after a switching command to switch the connection state of the plurality of windings is input to a winding switching device configured to switch the connection state of the plurality of windings is the switching timing.

14. The control device according to claim 10,
wherein the specifying unit specifies a first switching timing, which is the switching timing in a first phase of the AC motor, and a second switching timing, which is the switching timing in a second phase of the AC motor, and
the control value switching unit switches a control voltage value corresponding to the first phase from the first control voltage value to the second control voltage value based on the first switching timing specified by the specifying unit, and switches a control voltage value corresponding to the second phase from the first control voltage value to the second control voltage value based on the second switching timing specified by the specifying unit.

15. The control device according to claim 10, wherein the control value switching unit gradually changes the control voltage value from the first control voltage value to the second control voltage value.

16. A winding switching system comprising:
an AC motor capable of switching a connection state of a plurality of windings from a first connection state to a second connection state;
a power converter configured to convert power output from a power source into AC power and supply the AC power to the AC motor;
a winding switching device configured to execute zero crossing switching for switching the connection state of the plurality of windings from the first connection state to the second connection state at a zero crossing point of current flowing through the windings; and
a control device,
wherein the control device includes:
a specifying unit configured to specify a switching timing at which the winding switching device executes the zero crossing switching; and
a control value switching unit configured to switch a control voltage value, which is a voltage value to be applied to the AC motor from a first control voltage value to be used in the first connection state to a second control voltage value to be used in the second connection state, based on the switching timing specified by the specifying unit.

17. A control method for controlling an AC motor capable of switching a connection state of a plurality of windings from a first connection state to a second connection state, comprising:
a step of specifying a switching timing at which zero crossing switching for switching a connection state of the plurality of windings of the AC motor from the first connection state to the second connection state at a zero crossing point of current flowing through the windings is executed; and
a step of switching a control voltage value, which is a voltage value to be applied to the AC motor from a first control voltage value to be used in the first connection state to a second control voltage value to be used in the second connection state based on the specified switching timing.

18. The control device according to claim 11,
wherein the specifying unit specifies a first switching timing, which is the switching timing in a first phase of the AC motor, and a second switching timing, which is the switching timing in a second phase of the AC motor, and
the control value switching unit switches a control voltage value corresponding to the first phase from the first control voltage value to the second control voltage value based on the first switching timing specified by the specifying unit, and switches a control voltage value corresponding to the second phase from the first control voltage value to the second control voltage value based on the second switching timing specified by the specifying unit.

19. The control device according to claim 12,
wherein the specifying unit specifies a first switching timing, which is the switching timing in a first phase of the AC motor, and a second switching timing, which is the switching timing in a second phase of the AC motor, and
the control value switching unit switches a control voltage value corresponding to the first phase from the first control voltage value to the second control voltage value based on the first switching timing specified by the specifying unit, and switches a control voltage value corresponding to the second phase from the first control voltage value to the second control voltage value based on the second switching timing specified by the specifying unit.

20. The control device according to claim 13,
wherein the specifying unit specifies a first switching timing, which is the switching timing in a first phase of the AC motor, and a second switching timing, which is the switching timing in a second phase of the AC motor, and
the control value switching unit switches a control voltage value corresponding to the first phase from the first control voltage value to the second control voltage value based on the first switching timing specified by the specifying unit, and switches a control voltage value corresponding to the second phase from the first control voltage value to the second control voltage value based on the second switching timing specified by the specifying unit.

21. The control device according to claim 11, wherein the control value switching unit gradually changes the control voltage value from the first control voltage value to the second control voltage value.

22. The control device according to claim 12, wherein the control value switching unit gradually changes the control voltage value from the first control voltage value to the second control voltage value.

23. The control device according to claim 13, wherein the control value switching unit gradually changes the control voltage value from the first control voltage value to the second control voltage value.

24. The control device according to claim 14, wherein the control value switching unit gradually changes the control voltage value from the first control voltage value to the second control voltage value.
